(19) United States
(12) Patent Application Publication
(10) Pub. No.: US 2024/0040066 A1
(43) Pub. Date: Feb. 1, 2024

(54) METHOD FOR DISPLAYING PROMPT TEXT AND ELECTRONIC DEVICE

(71) Applicant: BEIJING DAJIA INTERNET INFORMATION TECHNOLOGY CO., LTD., Beijing (CN)

(72) Inventors: Mingming LIU, Beijing (CN); Jiahui HONG, Beijing (CN)

(21) Appl. No.: 18/362,297

(22) Filed: Jul. 31, 2023

(30) Foreign Application Priority Data
Aug. 1, 2022 (CN) 202210917399.4

(51) Int. Cl. H04N 5/222; G06V 20/40; G06V 40/16; G10L 17/02; G10L 25/57; G10L 17/22; H04N 23/63

(52) U.S. Cl. CPC H04N 5/2222; G06V 20/41; G06V 40/165; G10L 17/02; G10L 25/57; G10L 17/22; H04N 23/631

(57) ABSTRACT

A method for displaying a prompt text is provided, which belongs to the field of computer technologies. The method includes: collecting content information generated in a speaking process of a target object; obtaining identification information by identifying the content information, the identification information indicating speaking progress of the target object; and displaying the prompt text based on the identification information, so that a prompt text fragment as highlighted in the prompt text matches the speaking progress of the target object.

### CROSS-REFERENCE TO RELATED APPLICATIONS

The present disclosure is based on and claims priority to Chinese Patent Application No. 202210917399.4, filed on Aug. 1, 2022, the disclosure of which is herein incorporated by reference in its entirety.

### TECHNICAL FIELD

The present disclosure relates to the field of computer technologies, and more particularly, to a method for displaying a prompt text, and an electronic device.

### BACKGROUND

With the widespread popularity of the Internet and the increasing demand for communication, a prompt function is widely used in a variety of scenarios. Taking a video recording scenario as an example, when a user wants to record a video, the prompt function can be enabled on an electronic device, then the electronic device displays a prompt text during the video recording process, and text fragments in the prompt text scroll at a uniform speed so that the user can view the text fragments that need to say currently.

### SUMMARY

The present disclosure provides a method and apparatus for displaying a prompt text, an electronic device and a storage medium. The technical solutions of the present disclosure are summarized as follows.

According to some embodiments of the present disclosure, a method for displaying a prompt text is provided. The method includes: collecting content information generated in a speaking process of a target object; obtaining identification information by identifying the content information, wherein the identification information indicates speaking progress of the target object; and displaying the prompt text based on the identification information, so that a prompt text fragment as highlighted in the prompt text matches the speaking progress of the target object.

According to some embodiments of the present disclosure, an electronic device is provided. The electronic device includes a processor and a memory storing at least one computer program therein, wherein the processor, when loading and executing the at least one computer program, is caused to perform: collecting content information generated in a speaking process of a target object; obtaining identification information by identifying the content information, wherein the identification information indicates speaking progress of the target object; and displaying a prompt text based on the identification information, so that a prompt text fragment as highlighted in the prompt text matches the speaking progress of the target object.

According to some embodiments of the present disclosure, a non-volatile computer-readable storage medium storing instruction therein is provided, wherein the instructions, when executed by a processor of an electronic device, cause the electronic device to perform: collecting content information generated in a speaking process of a target object; obtaining identification information by identifying the content information, the identification information indicating speaking progress of the target object; and displaying the prompt text based on the identification information, so that a prompt text fragment as highlighted in the prompt text matches the speaking progress of the target object.

### BRIEF DESCRIPTION OF DRAWINGS

FIG. 1 is a schematic diagram of an implementation environment according to some embodiments of the present disclosure;

FIG. 2 is a flowchart of a method for displaying a prompt text according to some embodiments of the present disclosure;

FIG. 3 is a flowchart of another method for displaying a prompt text according to some embodiments of the present disclosure;

FIG. 4 is a flowchart of another method for displaying a prompt text according to some embodiments of the present disclosure;

FIG. 5 is a flowchart of another method for displaying a prompt text according to some embodiments of the present disclosure;

FIG. 6 is a schematic diagram of a video shooting interface according to some embodiments of the present disclosure;

FIG. 7 is a schematic diagram of a countdown duration according to some embodiments of the present disclosure;

FIG. 8 is a schematic diagram of a setup interface according to some embodiments of the present disclosure;

FIG. 9 is a schematic diagram of another video shooting interface according to some embodiments of the present disclosure;

FIG. 10 is a schematic diagram of a shooting completion interface according to some embodiments of the present disclosure;

FIG. 11 is a schematic diagram of a video processing interface according to some embodiments of the present disclosure;

FIG. 12 is a flowchart of another method for displaying a prompt text according to some embodiments of the present disclosure;

FIG. 13 is a structural block diagram of an apparatus for displaying a prompt text according to some embodiments of the present disclosure; and

FIG. 14 is a structural block diagram of an electronic device according to some embodiments of the present disclosure.

### DETAILED DESCRIPTION

The user information involved in the present disclosure is information authorized by a user or fully authorized by all parties.

Some embodiments of the present disclosure provide a method for displaying a prompt text. The method is performed by an electronic device. The electronic device displays a prompt text in a speaking process of a target object, and makes a prompt on content that the target object needs to say.

In some embodiments, the electronic device includes a desktop computer, a smartphone, a tablet computer or other electronic devices. The electronic device is installed with a target application, which is configured with a function of collecting information and identifying the information, and capable of collecting at least one type of information such as video information or voice information in a current scenario, and identifying the collected information. Moreover, the target application is also configured with a prompt function that can display a prompt text. In addition, the target application is also configured with a video shooting function, a video sharing function, etc.

In other embodiments, the electronic device includes a control device and a teleprompter, wherein the control device is, for example, a laptop computer, a smartphone, a tablet computer or other devices, and the teleprompter is, for example, a device for displaying a text.

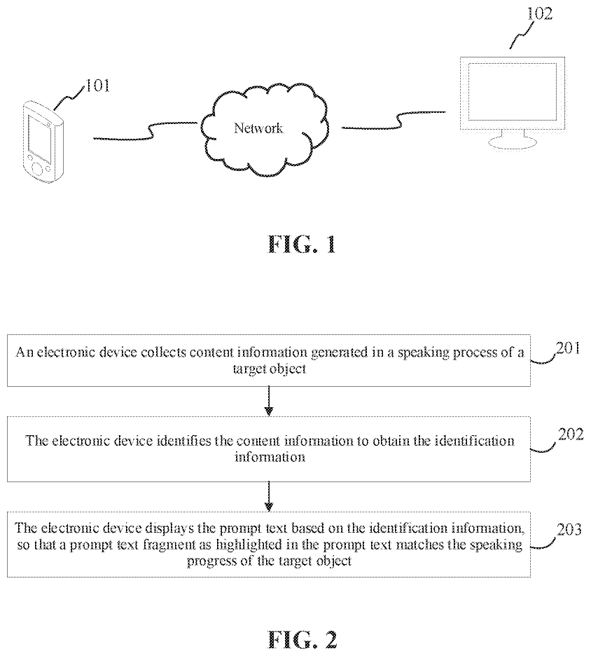

FIG. 1 is a schematic diagram of an implementation environment according to some embodiments of the present disclosure, the implementation environment includes a control device 101 and a teleprompter 102. The control device 101 and the teleprompter 102 are connected via a wired or wireless network.

The control device 101 is, but not limited to, a laptop computer, a smartphone, a tablet computer or other devices. The teleprompter 102 is equipped with a display screen, and is able to display a prompt text by the display screen.

In the embodiments of the present disclosure, the control device 101 can collect at least one type of information such as video information or voice information, and after identifying the collected information, controls the teleprompter 102 to display the prompt text.

In some embodiments, the control device 101 is installed with a target application, and the target application is configured with a function of collecting information, and is capable of collecting at least one type of information such as video information or voice information in the current scenario, and identifying the collected information. Further, the control device 101 controls the teleprompter 102 through the target application. In addition, the target application is also configured with a video shooting function, a video sharing function, etc.

FIG. 2 is a flowchart of a method for displaying a prompt text according to some embodiments. As shown in FIG. 2, this method is executed by an electronic device and includes the following steps.

In 201, the electronic device collects content information generated in a speaking process of a target object.

In the embodiments of the present disclosure, the electronic device displays a prompt text based on the speaking progress of the target object in the speaking process of the target object, to prompt the target object of content that needs to say, thereby achieving a prompt function. The speaking progress of the target object can be determined by the content information generated in the speaking process of the target object. Therefore, the electronic device will first collect the content information generated in the speaking progress of the target object.

The electronic device is located in a scenario where the target object is located. The electronic device can collect the content information in the speaking process of the target object. In some embodiments, the content information is a video fragment, the video fragment containing a speaking screen of the target object; in some other embodiments, the content information is a voice fragment, the voice fragment containing a voice made by the target object in the speaking process.

In 202, the electronic device identifies the content information to obtain the identification information.

The identification information indicates the speaking progress of the target object. For example, the identification information is a text fragment in the content information, or a position of the text fragment in the content information in the prompt text, etc. The specific representations of the identification information are not limited to the embodiments of the present disclosure.

In 203, the electronic device displays the prompt text based on the identification information, so that a prompt text fragment as highlighted in the prompt text matches the speaking progress of the target object.

In the embodiments of the present disclosure, the prompt text is configured to prompt the target object of the content that needs to say. In some embodiments, the prompt text is acquired in advance by the electronic device. The prompt text includes at least one text fragment. For example, the prompt text includes a plurality of lines of text, each line of text being a text fragment; or the prompt text includes a plurality of paragraphs of text, each paragraph of text being a text fragment.

In some embodiments, after obtaining the identification information, the electronic device determines a prompt text fragment based on the identification information, the prompt text fragment is a text segment that matches the speaking progress of the target object, that is, a text fragment corresponding to content that the target object is currently speaking. By displaying the prompt text fragment in a highlighting made, it is convenient for the target object to quickly find the prompt text fragment in the prompt text, thereby timely and effectively making a prompt on the target object.

The highlighting made includes a high-brightness mode, a bolding mode, a mode of changing font colors, a mode of enlarging font sizes, etc.

Considering that different objects speak at different speeds, even the same object speaks at different speeds when speaking different content, a mode of scrolling the prompt text at a uniform speed will cause a scrolling speed to be inconsistent with the speaking speed of the object. However, a mode of scrolling the prompt text at a uniform speed is not adopted in the method provided by the embodiments of the present disclosure, while the content information generated in the speaking process of the target object is collected, and identified to obtain the identification information configured to indicate the speaking progress of the target object, and then the prompt text is displayed based on the identification information. Even if the speaking speed of the target object changes, the identification information can also accurately represent the speaking progress of the target object, and thus can ensure that the prompt text fragment as highlighted is a text fragment that matches the speaking progress of the target object, thereby improving the accuracy and thus improving the prompt effect.

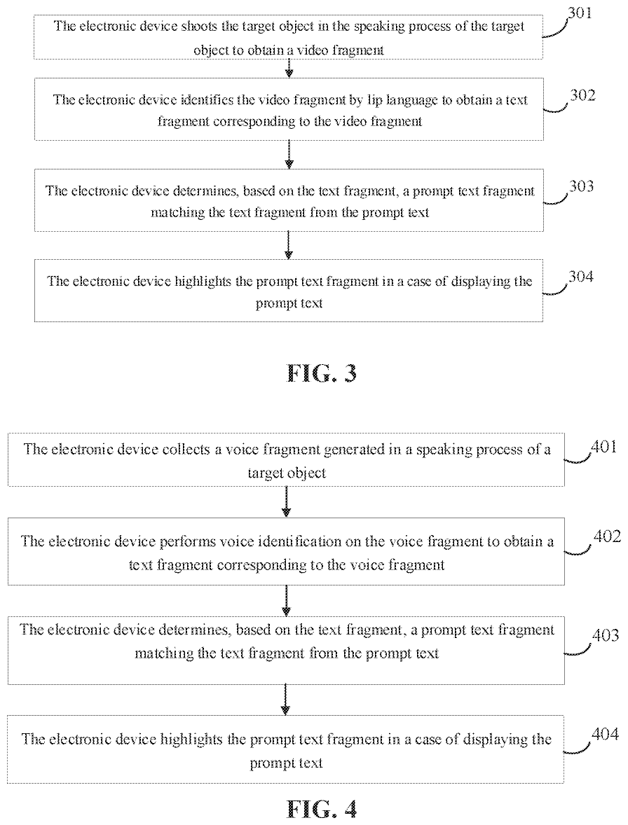

FIG. 3 is a flowchart of another method for displaying a prompt text according to some embodiments of the present disclosure. As shown in FIG. 3, the method is performed by an electronic device. In addition, taking the collected content information being a video fragment as an example, the process of displaying a prompt text based on the video fragment is described in this method. The method includes the following steps.

In 301, the electronic device shoots the target object in the speaking process of the target object to obtain a video fragment.

In the embodiments of the present disclosure, the electronic device displays a prompt text based on the speaking progress of the target object in the speaking process of the target object, to prompt the target object of content that needs to say, thereby achieving a prompt function. The speaking progress of the target object can be determined by the content information generated in the speaking process of the target object. Therefore, the electronic device will first collect the content information generated in the speaking progress of the target object.

According to the embodiments of the present disclosure, taking the collected content information being the video fragment as an example, the electronic device is placed around the target object so that the target object is located within a shooting range of the electronic device. The electronic device shoots the target object in the speaking process of the target object. The obtained video fragment includes a video frame of the target object in the speaking process. Then, the speaking progress of the target object is determined by identifying the video fragment.

In 302, the electronic device identifies the video fragment by lip language to obtain a text fragment corresponding to the video fragment.

After collecting the video fragment in which the speaking process of the target object is recorded, the electronic device identifies the video fragment by lip language. For example, the features of the change in mouth shape, and the like in the speaking process of the target object are identified to obtain the text fragment corresponding to the video fragment. The text fragment is the content in the video fragment that the target object says. Therefore, this text fragment is the identification information obtained by identifying the video fragment, which can indicate the speaking progress of the target object.

In some embodiments, the electronic device identifies a human face of the target object from the video fragment, extracts a mouth shape change feature of the target object, and then inputs the mouth shape change feature into a lip language identification model to obtain the text fragment corresponding to the mouth shape change feature.

In 303, the electronic device determines, based on the text fragment, a prompt text fragment matching the text fragment from the prompt text.

After the electronic device identifies the text fragment corresponding to the video fragment, it is necessary to match this text fragment with each text fragment in the prompt text to obtain the prompt text fragment that matches the text fragment in the prompt text.

In some embodiments, keyword features of the text fragment and keyword features of each text fragment in the prompt text are acquired, wherein the keyword features of any text fragment represent keywords included in the text fragment. Therefore, an overlap degree between the keyword features of each text fragment in the prompt text and the keyword features of the text fragment is determined, and a text fragment having the highest overlap degree in the prompt text is determined as the prompt text fragment that matches the text fragment.

If there is a plurality of text fragments in the prompt text that has the highest overlap degree with this text fragment, the text fragment that is prioritized in sequence and is not marked as “displayed” is preferentially selected. In the case that a text fragment is highlighted, the electronic device marks this text fragment as “displayed” to ensure that the text fragment that has been displayed will not be matched during subsequent text matching, thereby reducing the complexity of text matching.

In 304, the electronic device highlights the prompt text fragment in a case of displaying the prompt text.

In some embodiments, after determining the prompt text fragment, the electronic device also determines the position of the prompt text fragment in the prompt text, such that the text fragment located in this position is highlighted subsequently based on the position. The target object can speak with reference to the highlighted prompt text fragment.

In some embodiments, the position is a line number or paragraph number of the prompt text fragment in the prompt text. For example, in a case that the position is the line number, the entire line where the prompt text fragment is located is highlighted based on the line number; or, in a case that the position is the paragraph number, the entire paragraph where the prompt text fragment is located is highlighted based on the paragraph number.

In some embodiments, highlighting the prompt text fragment includes two modes.

In the first mode, the prompt text fragment is displayed in a target display style, the target display style is different from the display style of other text fragments in the prompt text.

The target display style includes a high-brightness mode, a bolding mode, a mode of changing font colors, a mode of enlarging font sizes, etc. Each of these target display styles can make the prompt text fragment different from other text fragments, wherein the prompt text fragment in this prompt text becomes more prominent with a better prompting effect.

In the second mode, the respective text fragments in the prompt text are enabled to scroll, so that the prompt text fragments are displayed in a focal position in a current interface.

The current display interface is provided with the focal position, which is located at the top or middle of the current display interface, and is more likely to attract the attention of the target object than other positions. Each time the prompt text is displayed, the prompt text fragment determined this time is displayed in the focal position in the current display interface, so that the target object can view the content that needs to say. As the speaking content of the target object changes, after the next time a new prompt text fragment is identified, a new prompt text fragment is displayed at that focal position, and the corresponding originally displayed prompt text fragment and other adjacent text fragments scroll upward. Therefore, from an overall perspective, the respective text fragments in the prompt text are displayed in a scrolled manner, and the scrolling progress matches the speaking progress of the target object.

In some embodiments, the focal position is in a line in the current display interface for displaying the line where the prompt text fragment is located, or the focal position is used to display the paragraph where the prompt text fragment is located, and the size of the focal position may change with the number of lines of the paragraph where the prompt text fragment is located.

According to the method provided by the embodiments of the present disclosure, the video fragment generated in the speaking process of the target object is collected without using a mode in which the prompt text scrolls at a uniform speed, then the video fragment is identified by lip language to obtain a text fragment configured to indicate the speaking progress of the target object, and the prompt text fragment that matches the text fragment is determined from the prompt text and displayed in a highlighted manner, making the prompt text fragment more prominent, and facilitating the target object to review the content that needs to say. Even if the speaking speed of the target object changes, the prompt text fragment is also the content that the target object is currently speaking, and thus can ensure that the prompt text fragment as highlighted is a text fragment that matches the speaking progress of the target object, thereby improving the accuracy and thus improving the prompt effect.

According to the method provided by the embodiments of the present disclosure, after the text fragment spoken by the target object is identified, the prompt text fragment that matches the text fragment can be determined from the prompt text, and is highlighted, so that the text fragment can be used as a minimum display unit to ensure that the prompt text fragment as highlighted is a text fragment that matches the speaking progress of the target object, thereby improving the accuracy, and thus improving the prompt effect.

According to the method provided by the embodiments of the present disclosure, the prompt text fragment is highlighted. The prompt text fragment is displayed in the target display style, so that the prompt text fragment is different from the display style of other text fragments in the prompt text; or the respective text fragment in the prompt text is enabled to scroll, so that the prompt text fragment is displayed in the focal position in the current display interface. The above method of highlighting the prompt text fragment can make the prompt text fragment more prominent, so that the target object can review the content that needs to say.

FIG. 4 is a flowchart of another method for displaying a prompt text according to some embodiments of the present disclosure. As shown in FIG. 4, the method is performed by an electronic device. Taking the collected content information being a voice fragment as an example, the process of displaying the prompt text based on the voice fragment is described in this method. The method includes the following steps.

In 401, the electronic device collects a voice fragment generated in a speaking process of a target object.

In the embodiments of the present disclosure, the electronic device displays a prompt text based on the speaking progress of the target object in the speaking process of the target object, to prompt the target object content that needs to say, thereby achieving a prompt function. The speaking progress of the target object can be determined by the content information generated in the speaking process of the target object. Therefore, the electronic device will first collect the content information generated in the speaking progress of the target object.

According to the embodiments of the present disclosure, taking the collected content information being the voice fragment as an example, the electronic device is placed around the target object so that the target object is located within a shooting range of the electronic device. The electronic device collects the voice of the target object in the speaking process of the target object. The obtained voice fragment includes a voice in the speaking process of the target object. Then, the speaking progress of the target object is determined by identifying the voice fragment.

In 402, the electronic device performs voice identification on the voice fragment to obtain a text fragment corresponding to the voice fragment.

After collecting the voice fragment in which the speaking process of the target object is recorded, the electronic device performs voice identification on the voice fragment to obtain the text fragment corresponding to the voice fragment. The text fragment is the content included in the voice fragment. Therefore, this text fragment is the identification information obtained by identifying the voice fragment, which can indicate the speaking progress of the target object.

In 403, the electronic device determines, based on the text fragment, a prompt text fragment matching the text fragment from the prompt text.

In 404, the electronic device highlights the prompt text fragment in a case of displaying the prompt text.

The steps 403-404 are similar to the steps 303-304 above, and will not be repeated herein.

According to the method provided by the embodiments of the present disclosure, the voice fragment generated in the speaking process of the target object is collected without using a mode in which the prompt text scrolls at a uniform speed, then the voice fragment is subjected to voice identification to obtain a text fragment configured to indicate the speaking progress of the target object, and the prompt text fragment that matches the text fragment is determined from the prompt text and displayed in a highlighted manner, making the prompt text fragment more prominent, and facilitating the target object to review the content that needs to say. Even if the speaking speed of the target object changes, the prompt text fragment is also the content that the target object is currently speaking, and thus can ensure that the prompt text fragment as highlighted is a text fragment that matches the speaking progress of the target object, thereby improving the accuracy and thus improving the prompt effect.

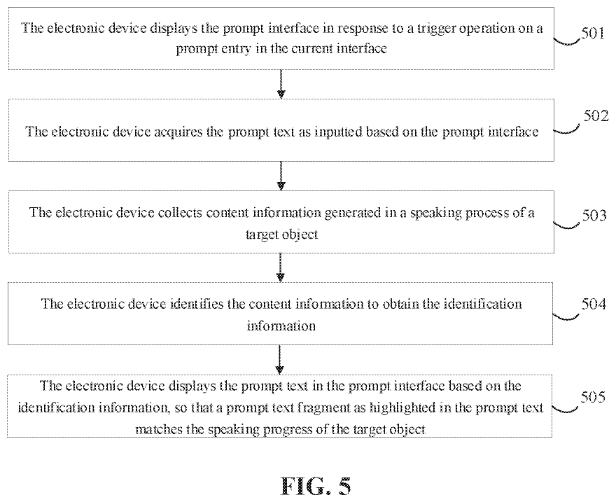

FIG. 5 is a flowchart of a method for displaying a prompt text according to some embodiments. As shown in FIG. 5, this method is executed by an electronic device and includes the following steps.

In 501, the electronic device displays a prompt interface in response to a trigger operation on a prompt entry in the current interface.

In the embodiments of the present disclosure, the current interface displayed by the electronic device is provided with a prompt entry, the prompt entry is configured to trigger a prompt function, so that the electronic device displays the prompt interface in response to the trigger operation on the prompt entry, thereby displaying the prompt text in the prompt interface.

The current interface displayed by the electronic device is, for example, a home page in a target application, a video shooting interface, an image shooting interface, etc.

In some embodiments, the method in the embodiments of the present disclosure is applied to a scenario where a video is shot, wherein the video needs to be shot for the target object using the electronic device, and a prompt text also needs to be viewed in the shooting process to remind the target object of the content that needs to say. In the scenario, the current interface displayed by the electronic device is the video shooting interface, and the video shooting interface displays a prompt entry, wherein the prompt entry is configured to trigger the prompt function; and the video shooting interface displays a shoot entry, wherein the shoot entry is configured to start video shooting. Therefore, the electronic device displays the prompt interface in response to a trigger operation on the prompt entry, thereby displaying the prompt text in the prompt interface; and starts video shooting in response to a trigger operation on the shoot entry.

It should be noted that, before the shoot entry is triggered, the electronic device has not actually started shooting video, a viewing frame is displayed in the video shooting interface at this time, and the viewing frame displays a preview screen within the shooting range of the electronic device. A user who uses the electronic device may adjust the shooting range by adjusting the position of the electronic device, so that the target object is located within the shooting range of the electronic device. Therefore, when the electronic device shoots a video subsequently, a screen containing the target object can be shot.

In some embodiments, in order to facilitate subsequent video shooting, the electronic device can maintain a display state of the video shooting interface. That is, the electronic device still displays the video shooting interface in the case of displaying the prompt interface in response to the trigger operation on the prompt entry. Therefore, the prompt interface can be displayed at the same time as the video shooting interface. Schematically, a terminal displays the prompt interface on an upper layer of the video shooting interface in response to the trigger operation on the prompt entry. For example, the prompt interface is in a transparent or translucent state. The prompt interface is displayed on the upper layer of the video shooting interface, without blocking an area of the video shooting interface, thereby avoiding the target object from being blocked in the process of shooting the target object.

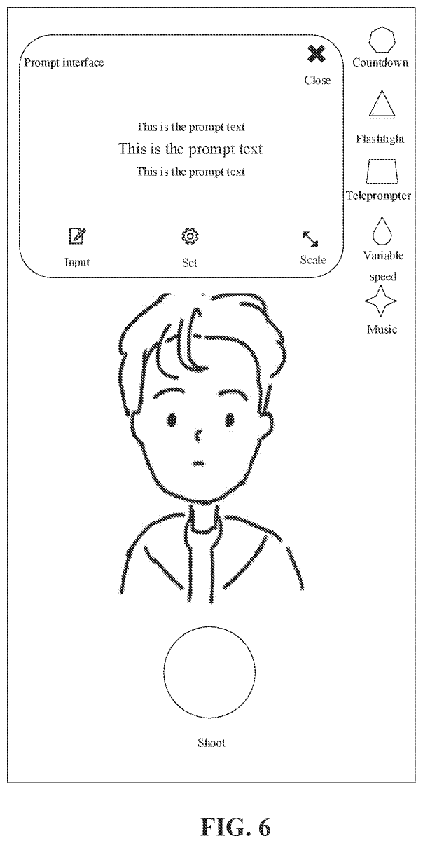

For example, the video shooting interface is shown in FIG. 6. The video shooting interface includes a prompt entry “teleprompter” and a shoot entry “shooting”. After the user triggers the prompt entry “teleprompter”, the electronic device displays the prompt interface.

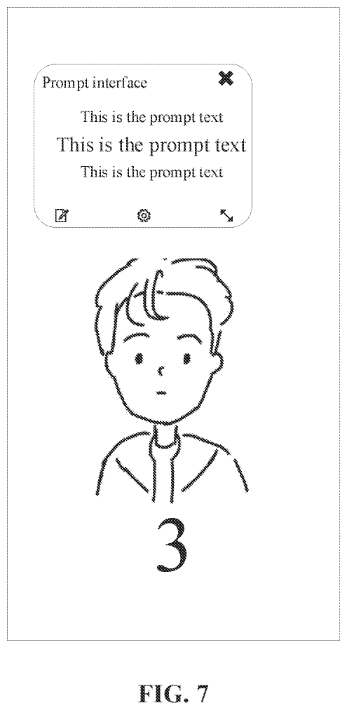

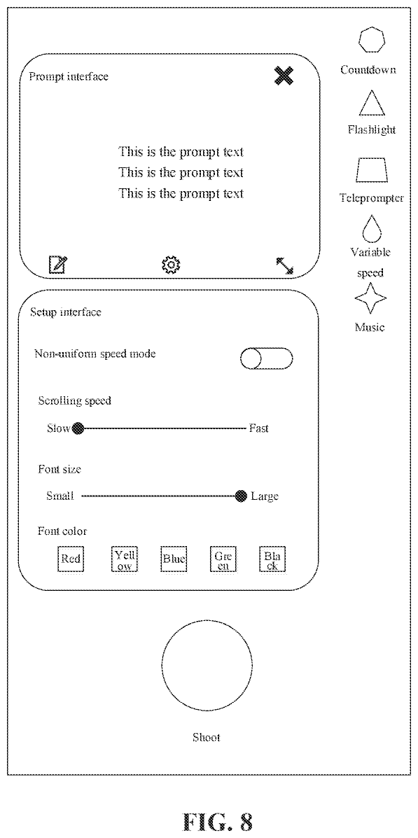

In other embodiments, in addition to the prompt entry and the shoot entry, the video shooting interface also displays other function entries. For example, as shown in FIG. 6, a countdown option is displayed in the video shooting interface. A delay duration can be set by triggering the countdown option. In addition, the video shooting is started after the delay duration is elapsed each time the shoot entry is triggered. As shown in FIG. 7, a countdown duration is displayed within the delay duration, thereby providing the user with sufficient preparation time. In addition, a flashlight option is also displayed in the video shooting interface, and a flashlight function can be started by triggering this flashlight option while a video is shot. A variable speed option is displayed in the video shooting interface, a double speed can be set by triggering this variable speed option, and the video is accelerated or decelerated after the video shooting is completed. A music option is also displayed in the video shooting screen, such that the background music of the video can be set by triggering this music option.

In other embodiments, the current interface displayed by the electronic device is a different interface from the video shooting interface. In response to the trigger operation on the prompt entry in the current interface, the video shooting interface and the prompt interface are displayed. A video may be shot based on the video shooting interface, without the need to enter the video shooting interface separately.

In 502, the electronic device acquires the prompt text as inputted based on the prompt interface.

The prompt text is inputted by the user on the electronic device, by a copying operation, or by importing the content of a selected text document. The content of the prompt text is consistent with the content that the target object needs to say, and the subsequent display of the prompt text can play the role of prompting the target object.

In some embodiments, as shown in FIG. 6, the prompt interface includes an input entry. The prompt interface is switched to the inputtable state in response to the trigger operation on the input entry, and then the user can input the prompt text in the prompt interface. Then, the top of the prompt interface is clicked or a close option is triggered, and the prompt interface is switched to the non-inputtable state. Then, the prompt text that has been inputted is modified by triggering the input entry again, for example, a new text fragment is added or any one or more of text fragments are deleted.

In other embodiments, as shown in FIG. 6, the prompt interface includes a setup option. As shown in FIG. 8, a setup interface is displayed in response to the trigger operation on the setup option. A displaying style, e.g., front sizes and font colors, of the prompt text can be set by this setup interface. This setup interface is closed in response to the trigger operation on the close option in the prompt interface, or in response to a re-trigger operation on the setup option. Alternatively, in response to the trigger operation on the shoot entry in the video shooting interface, it is necessary to start video shooting, and the setup interface can be automatically closed at this time.

In other embodiments, as shown in FIG. 6, the prompt interface includes a scale option. In response to a trigger operation on the scale option, the prompt interface is set to a movable state. At this time, the position of the prompt interface in the current interface is adjusted by moving the prompt interface, or the size of the prompt interface is adjusted by scaling the prompt interface in or out.

In 503, the electronic device collects content information generated in a speaking process of a target object.

After the completion of inputting the prompt text, the electronic device begins to make a prompt, so a prompt function is achieved by performing steps 503 to 505.

In some embodiments, as shown in FIG. 6, in the case that the embodiment of the present disclosure is applied to a scenario in which a video is shot, the prompt text is inputted into the prompt interface, and then the video shooting is not started for the time being, until the electronic device begins to shoot the video in response to the trigger operation on a shoot entry. In addition, steps 503-505 are performed to display the prompt text. That is, the electronic device performs video shooting in the process of displaying the prompt text in the prompt interface.

In other embodiments, the prompt interface includes a startup option. In response to the trigger operation on the startup option, it is indicated that the prompt text has been set. Therefore, the electronic device performs steps 503-505 to achieve the prompt function.

It should be noted that steps 503-505 in the embodiments of the present disclosure may be executed at any time, as long as the prompt text has been inputted while being executed. The execution timing of steps 503-505 is not limited in the embodiments of the present disclosure.

In 504, the electronic device identifies the content information to obtain the identification information.

The identification information is configured to indicate the speaking progress of the target object. The specific process of step 504 is similar to steps 202, 302, and 402 above, and will not be repeated herein.

In 505, the electronic device displays the prompt text in the prompt interface based on the identification information, so that the prompt text fragment as highlighted in the prompt text matches the speaking progress of the target object.

The specific process of step 505 is similar to steps 203, 303, and 403 above, and will not be repeated herein.

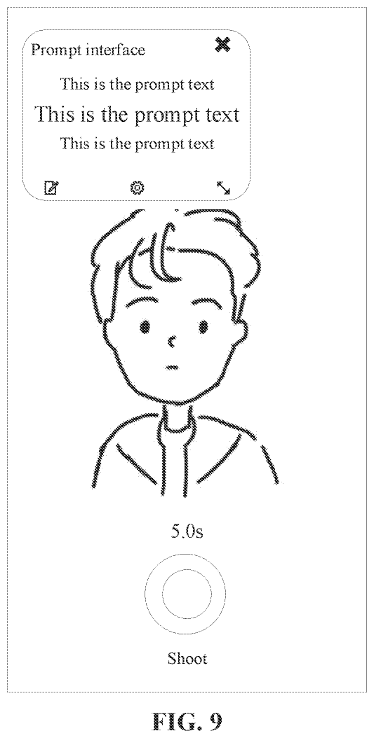

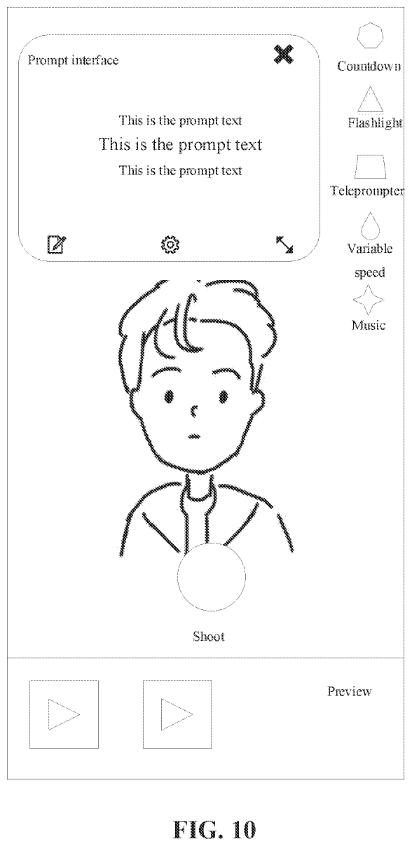

In some embodiments, in the scenario of video shooting, by performing steps 503-505 above, the prompt text is displayed while a video is shot, and the video shooting interface as shown in FIG. 9 is displayed. The duration of the currently shot video is displayed in the video shooting interface. This method also supports segmented shooting. For example, the shoot entry is displayed during video shooting. The shooting is stopped in response to a first trigger operation on the shoot entry. The shot video fragment is saved, and then shooting is restarted in response to a first trigger operation on the shoot entry. In response to a second trigger operation on the shoot entry, the shooting is completed, and a shooting completion interface shown in FIG. 10 is displayed, the shooting completion interface includes video fragments saved during the shooting process.

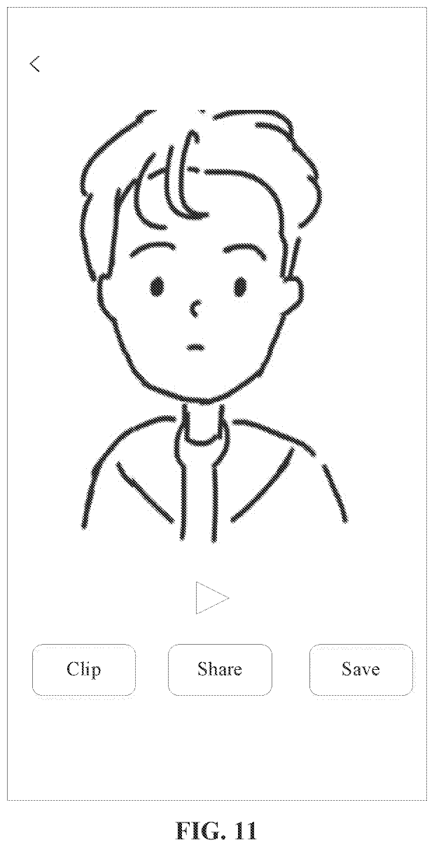

In some other embodiments, in a case that a video segment is shot each time, the electronic device displays a preview entry of the video segment, and previews the video segment in response to a trigger operation on the preview entry. As shown in FIG. 10, preview entries of two video fragments are displayed in the shooting completion interface, and the target object can preview any video fragment by clicking the preview entry of this video fragment. In addition, the method also supports merging at least two shot video fragments to obtain a complete video. As shown in FIG. 11, a function option such as a clip option, a share option, or a save option is displayed after the video is shot, so that the video can be clipped, shared, or stored in a specified medium library. For example, during the video clipping process, music tracks and subtitle tracks are generated in the video clipping interface. The track is a container for video clipping footage, the video clip footages including background music, titles, and the like. Different visual effects can be presented by setting the clipping footage of the video in different tracks and different periods. A video and background music of a video fragment in the video can be set in response to a trigger operation on the music track. In response to a trigger operation on the subtitle track, a screen in the video can be selected, and subtitles are added to this screen.

It should be noted that the above steps 503-505 are described by displaying the prompt text according to the speaking progress of the target object as an example. However, in other embodiments, the prompt text is not displayed according to the speaking progress of the target object, but the respective text fragments in the prompt text scroll at a uniform speed. The above two display modes may be set by the target object or set by default by the electronic device.

In some embodiments, the prompt interface includes a mode option. The mode option is configured to turn on a uniform speed mode or a non-uniform speed mode. The uniform speed mode is configured to enable each text fragment in the prompt text to scroll at a uniform speed. The non-uniform speed mode is configured to display the prompt text based on the speaking progress of the target object.

For example, the mode option is displayed in the setup interface shown in FIG. 8. The target object determines the uniform speed mode or the non-uniform speed mode through the mode option. Optionally, the mode option is turned on, indicating that the uniform speed mode is turned on; and the mode option is turned off, indicating that the non-uniform speed mode is turned on. Alternatively, the mode option is turned on, indicating that the non-uniform speed mode is turned on; and the mode option is turned off, indicating that the uniform mode is turned on.

In the case that the uniform speed mode is turned on, each text fragment in the prompt text scrolls at a preset uniform speed; and in the case that the non-uniform speed mode is turned on, the prompt text is displayed based on the speaking progress of the target object. In the case that the non-uniform speed mode is turned on based on the mode option, the electronic device performs the above steps 503 to 505 while displaying the prompt text. However, each text fragment in the prompt text is displayed in a scrolling manner according to a preset speed, in the case that the uniform speed mode is turned on based on the mode option. This preset speed is determined by the electronic device according to the speed at which people are speaking in general, or set by the target object.

For example, as shown in FIG. 8, the setup interface includes a scrolling speed adjustment area, the rolling speed adjustment area including a slider. The preset speed is adjusted by moving the slider. The slider slides from left to right, and the preset speed gradually increases. The target object can adjust the preset speed according to its own speaking speed. In addition, the scrolling speed adjustment area is displayed only in the case that the uniform speed mode is turned on, and then the preset speed can be adjusted. In the case that the non-uniform speed mode is turned on, the scrolling speed adjustment area will be switched to a hidden state, and no longer displayed; or the scrolling speed will be adjusted to a non-editable state, and the slider is not allowed to operate, so as to ensure that the preset speed cannot be adjusted in the non-uniform speed mode.

According to the method provided by the embodiments of the present disclosure, the prompt text is displayed according to the speaking progress of the target object. That is, the content information generated in the speaking process of the target object is collected, and identified to obtain the identification information configured to indicate the speaking progress of the target object, and then the prompt text is displayed based on the identification information. Even if the speaking speed of the target object changes, the identification information can also accurately represent the speaking progress of the target object, and thus can ensure that the prompt text fragment as highlighted is a text fragment that matches the speaking progress of the target object, thereby improving the accuracy and thus improving the prompt effect.

Further, some embodiments of the present disclosure provide a prompt interface. The functions of inputting the prompt text, displaying the prompt text, editing the prompt text, etc. can be achieved based on the prompt interface, facilitating the target object to set the prompt text, and thus ensuring the accuracy of the prompt text.

The prompt interface includes a mode option. The mode option is configured to turn on a uniform speed mode or a non-uniform speed mode. The prompt text is displayed based on the speaking progress of the target object in the case that the non-uniform speed mode is turned on. Even if the speaking speed of the target object changes, it can be ensured that the prompt text fragment as highlighted is a text fragment that matches the speaking progress of the target object, thereby improving the accuracy and thus improving the prompt effect. In the case that the uniform speed mode is turned on, each text fragment in the prompt text scrolls at a preset speed, thereby simplifying the operation and improving efficiency. These two modes may be selected as needed, thereby improving flexibility.

Moreover, in a scenario where a video is shot, the video shooting interface displays a prompt entry. In response to a trigger operation on the prompt entry, the prompt interface is displayed, but the video shooting interface is still displayed. Therefore, the prompt interface is displayed at the same time as the video shooting interface. In the subsequent shooting scenario, video shooting is carried out in the process of displaying the prompt text in the prompt interface to remind the target object of the content that needs to say, thereby improving the prompt effect of the target object during the video shooting process. The current interface may also be different from the video shooting interface. In response to the trigger operation of the prompt entry in the current interface, the video shooting interface and the prompt interface are directly displayed, without the need to enter the video shooting interface separately, thereby improving the convenience of displaying the prompt interface.

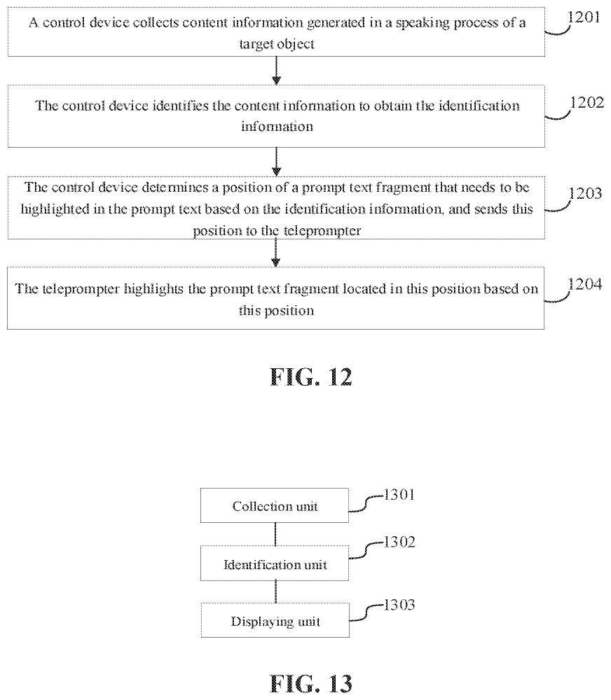

FIG. 12 is a flowchart of another method for displaying a prompt text according to some embodiments of the present disclosure. As shown in FIG. 12, the method is performed by a control device and a teleprompter alternatively. The method includes the following steps.

In 1201, the control device collects content information generated in a speaking process of a target object.

In the embodiments of the present disclosure, the control device collects at least one type of information such as video information or voice information, and after identifying the collected information, controls the teleprompter to display the prompt text.

In some embodiments, the control device is installed with a target application, and the target application is configured with a function of collecting information, and is capable of collecting at least one type of information such as video information or voice information in the current scenario, and identifying the collected information. Further, the control device controls the teleprompter through the target application.

The step 1201 similar to step 201 is executed by the control device, and thus will not be repeated herein.

In 1202, the control device identifies the content information to obtain the identification information.

The specific process of step 1202 is similar to steps 202, 302, and 402 above, performed by the control device, and thus will not be repeated herein.

In 1203, the control device determines a position of a prompt text fragment that needs to be highlighted in the prompt text based on the identification information, and sends this position to the teleprompter.

The identification information indicates the speaking progress of the target object. For example, the identification information is a text fragment in the content information, or a position of the text fragment in the content information in the prompt text, etc. The specific representations of the identification information are not limited to the embodiments of the present disclosure.

After obtaining the identification information, the control device determines a prompt text fragment based on the identification information, the prompt text fragment being a text segment that matches the speaking progress of the target object, that is, a text fragment corresponding to content that the target object is currently speaking. After determining the prompt text fragment, the control device also determines the position of the prompt text fragment in the prompt text, and sends this position to the teleprompter, such that the teleprompter displays the prompt text fragment in a highlighted manner according to this position.

In 1204, the teleprompter highlights the prompt text fragment located in this position based on this position.

After receiving the position sent by the control device, the teleprompter finds the prompt text fragment from the prompt text based on this position and highlights the prompt text fragment. In some embodiments, this position is a line number or paragraph number of the prompt text fragment in the prompt text. For example, in a case that the position is the line number, the entire line where the prompt text fragment is located is highlighted based on this line number; or, in a case that the position is the paragraph number, the entire paragraph where the prompt text fragment is located is highlighted based on this paragraph number. By highlighting the prompt text fragment, it is convenient for the target object to quickly find the prompt text fragment in the prompt text, thereby timely and effectively making a prompt on the target object.

This embodiment of the present disclosure may also be applied in a speech scenario. In the speaking process of the target object, the control device is disposed near the target object and configured to collect the content information of the target object, while the teleprompter is disposed in front of the target object, and the target object can view the prompt text displayed by the teleprompter.

Some embodiments of the present disclosure provide a method for displaying a prompt text, which is performed by a control device and a teleprompter alternatively. The control device collects the content information generated in the speaking process of the target object, and after identifying the collected content information, controls the teleprompter to display the prompt text. The control device and the teleprompter are two separate devices, and are no longer limited to the same device. Therefore, the control device and the teleprompter may be placed in different positions as needed. For example, the control device is placed in a position conducive to collecting content information, and the teleprompter is placed in a position where the target object is easy to see, which can improve the collection quality and the prompt effect, and achieve a wider application scope.

FIG. 13 is a structural block diagram of an apparatus for displaying a prompt text according to some embodiments of the present disclosure. Referring to FIG. 13, the apparatus includes:
a collection unit 1301, configured to collect content information generated in a speaking process of a target object; an identification unit 1302, configured to identify the content information to obtain identification information, the identification information indicating the speaking progress of the target object; and a displaying unit 1303, configured to display the prompt text based on the identification information, so that the prompt text fragment as highlighted in the prompt text matches the speaking progress of the target object.

In some embodiments, the collection unit 1301 includes: a shooting subunit configured to shoot the target object in the speaking process of the target object to obtain a video fragment; and the identification unit 1302 includes a lip language identification subunit configured to identify the video fragment by lip language to obtain a text fragment corresponding to the video fragment.

In some embodiments, the collection unit 1301 includes: a shooting subunit configured to collect a voice fragment generation in the speaking process of the target object; and the identification unit 1302 includes a lip language identification subunit configured to perform voice identification on the voice fragment to obtain a text fragment corresponding to the voice fragment.

In some embodiments, the identification information is a text fragment spoken by the target object. The displaying unit 1303 includes a determining subunit configured to determine, based on the text fragment, a prompt text fragment that matches the text fragment from the text fragment; and a displaying subunit configured to highlight the prompt text fragment in the case that the prompt text is displayed.

In some embodiments, the displaying subunit is configured to display the prompt text fragment in a target display style, the target display style is different from the display style of other text fragments in the prompt text; or the displaying subunit is configured to scroll each text fragment in the prompt text, so that this prompt text fragment is displayed in the focal position in the current interface.

In some embodiments, the apparatus further includes an acquisition unit configured to acquire the prompt text as inputted based on a prompt interface; and a displaying unit 1303 configured to display the prompt text in the prompt interface based on the identification information, so that the prompt text fragment as highlighted in the prompt text matches the speaking progress of the target object.

In some embodiments, the apparatus further includes a prompt interface displaying unit configured to display the prompt interface in response to a trigger operation on a prompt entry in the current interface.

In some embodiments, the current interface is a video shooting interface. The apparatus further includes a shooting unit configured to shoot a video in the process of displaying the prompt text on the prompt interface.

In some embodiments, the prompt interface includes a mode option. The mode option is configured to turn on a uniform speed mode or a non-uniform speed mode. The uniform speed mode is configured to enable each text fragment in the prompt text to scroll at a uniform speed. The non-uniform speed mode is configured to display the prompt text based on the speaking progress of the target object. The collection unit 1301 is configured to perform the step of collecting the content information generated in the speaking process of the target object in the case that the non-uniform speed mode is turned on based on the mode option.

In some embodiments, the displaying unit 1303 is configured to display each text fragment in the prompt text in a scrolling manner based on a preset speed in the case that the uniform speed mode is turned on based on the mode option.

In the embodiments of the present disclosure, the content information generated in the speaking process of the target object is collected, and identified to obtain the identification information configured to indicate the speaking progress of the target object, and then the prompt text is displayed based on the identification information. Even if the speaking speed of the target object changes, the identification information can also accurately represent the speaking progress of the target object, and thus can ensure that the prompt text fragment as highlighted is a text fragment that matches the speaking progress of the target object, thereby improving the accuracy and thus improving the prompt effect.

With respect to the apparatus for displaying a prompt text in the foregoing embodiments, the specific manner in which each unit performs the operation has been described in detail in the embodiments of the relevant methods, and a detailed description will not be given here.

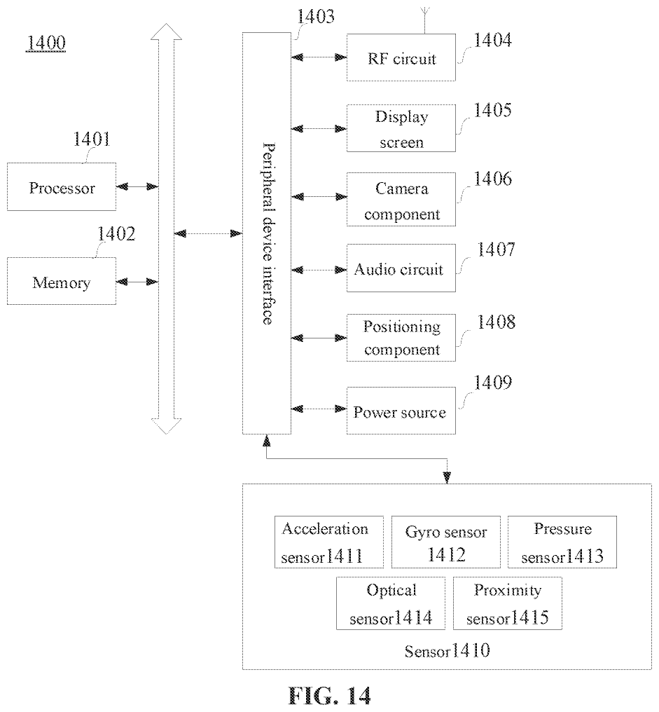

FIG. 14 is a structural block diagram of an electronic device according to some embodiments of the present disclosure. In some embodiments, the electronic device 1400 includes a desktop computer, a laptop, a tablet computer, a smartphone or other electronic devices. The electronic device 1400 may also be called user equipment (UE), a portable electronic device, a laptop electronic device, a desktop electronic device, or other names.

Generally, the electronic device 1400 includes a processor 1401 and a memory 1402.

In some embodiments, the processor 1401 includes one or more processing cores, such as a 4-core processor and an 8-core processor. In some embodiments, the processor 1401 is implemented by at least one hardware of a digital signal processing (DSP), a field-programmable gate array (FPGA), and a programmable logic array (PLA). In some embodiments, the processor 1401 also includes a main processor and a coprocessor. The main processor is a processor configured to process the data in an awake state, and is also called a central processing unit (CPU). The coprocessor is a low-power-consumption processor configured to process the data in a standby state. In some embodiments, the processor 1401 is integrated with a graphics processing unit (GPU), which is configured to render and draw the content that needs to be displayed by a display screen. In some embodiments, the processor 1401 also includes an artificial intelligence (AI) processor configured to process computational operations related to machine learning.

In some embodiments, the memory 1402 includes one or more computer-readable storage mediums, which can be non-transitory. In some embodiments, the memory 1402 also includes a high-speed random access memory, as well as a non-volatile memory, such as one or more disk storage devices and flash storage devices. In some embodiments, a non-transitory computer-readable storage medium in the memory 1402 is configured to store an executable instruction, which is executed by the processor 1401 to implement the method for displaying a prompt text provided by any method embodiment in the present disclosure.

In some embodiments, the electronic device 1400 also optionally includes a peripheral device interface 1403 and at least one peripheral device. The processor 1401, the memory 1402, and the peripheral device interface 1403 are connected by a bus or a signal line. In some embodiments, each peripheral device is connected to the peripheral device interface 1403 by a bus, a signal line or a circuit board. Specifically, the peripheral device includes at least one of a radio frequency (RF) circuit 1404, a display screen 1405, a camera 1406, an audio circuit 1407, a positioning component 1408 and a power source 1409.

The peripheral device interface 1403 is configured to connect the at least one peripheral device related to input/output (I/O) to the processor 1401 and the memory 1402. In some embodiments, the processor 1401, the memory 1402 and the peripheral device interface 1403 are integrated on the same chip or circuit board. In some other embodiments, any one or two of the processor 1401, the memory 1402 and the peripheral device interface 1403 are implemented on a separate chip or circuit board, which is not limited in the present embodiment.

The RF circuit 1404 is configured to receive and send an RF signal, also referred to as an electromagnetic signal. The RF circuit 1404 communicates with a communication network and other communication devices via the electromagnetic signal. The RF circuit 1404 converts the electrical signal into the electromagnetic signal for transmission, or converts the received electromagnetic signal into the electrical signal. In some embodiments, the RF circuit 1404 includes an antenna system, an RF transceiver, one or more amplifiers, a tuner, an oscillator, a digital signal processor, a codec chipset, a subscriber identity module card, and the like. In some embodiments, the RF circuit 1404 can communicate with other electronic devices via at least one wireless communication protocol. The wireless communication protocol includes, but is not limited to, world wide web, a metropolitan area network, intranet, various generations of mobile communication networks (2G, 3G, 4G, and 5G), a wireless local area network, and a wireless fidelity (WiFi) network. In some embodiments, the RF circuit 1404 also includes near field communication (NFC) related circuits, which is not limited to the present disclosure.

The display screen 1405 is configured to display a user interface (UI). In some embodiments, the UI includes graphics, text, icons, videos, and any combination thereof. When the display screen 1405 is a touch display screen, the display screen 1405 also has the capacity to acquire touch signals on or over the surface of the display screen 1405. In some embodiments, the touch signal is inputted into the processor 1401 as a control signal for processing. At this time, the display screen 1405 is also configured to provide virtual buttons and/or virtual keyboards, which are also referred to as soft buttons and/or soft keyboards. In some embodiments, one display screen 505 is disposed on the front panel of the electronic device 1400. In some other embodiments, at least two display screens 1405 are disposed respectively on different surfaces of the electronic device 1400 or in a folded design. In further embodiments, the display screen 1405 is a flexible display screen disposed on the curved or folded surface of the electronic device 1400. Even the display screen 1405 has an irregular shape other than a rectangle. That is, the display screen 1405 is an irregular-shaped screen. In some embodiments, the display screen 1405 is prepared from a material such as a liquid crystal (LCD), an organic light-emitting diode (OLED), etc.

The camera component 1406 is configured to capture images or videos. In some embodiments, the camera component 1406 includes a front camera and a rear camera. Usually, the front camera is placed on the front panel of the electronic device, and the rear camera is placed on the back of the electronic device. In some embodiments, at least two rear cameras are disposed, and are at least one of a main camera, a depth-of-field camera, a wide-angle camera, and a telephoto camera respectively, so as to realize a background blurring function achieved by fusion of the main camera and the depth-of-field camera, panoramic shooting and virtual reality (VR) shooting functions achieved by fusion of the main camera and the wide-angle camera or other fusion shooting functions. In some embodiments, the camera component 1406 also includes a flashlight. In some embodiments, the flashlight is a mono-color temperature flashlight or a two-color temperature flashlight. The two-color temperature flash is a combination of a warm flashlight and a cold flashlight and can be used for light compensation at different color temperatures.

In some embodiments, the audio circuit 1407 includes a microphone and a speaker. The microphone is configured to collect sound waves of users and environments, and convert the sound waves into electrical signals which are input into the processor 1401 for processing, or input into the RF circuit 1404 for voice communication. For the purpose of stereo acquisition or noise reduction, there are a plurality of microphones respectively disposed at different locations of the electronic device 1400. In some embodiments, the microphone is an array microphone or an omnidirectional acquisition microphone. The speaker is then configured to convert the electrical signals from the processor 1401 or the RF circuit 1404 into the sound waves. In some embodiments, the speaker is a conventional film speaker or a piezoelectric ceramic speaker. When the speaker is the piezoelectric ceramic speaker, the electrical signal can be converted into not only human-audible sound waves but also the sound waves which are inaudible to humans for the purpose of ranging and the like. In some embodiments, the audio circuit 1407 also includes a headphone jack.

The positioning component 1408 is configured to locate the current geographic location of the electronic device 1400 to implement navigation or location based service (LBS).

The power source 1409 is configured to power up various components in the electronic device 1400. In some embodiments, the power source 1409 is alternating current, direct current, a disposable battery, or a rechargeable battery. When the power source 1409 includes the rechargeable battery, the rechargeable battery is a wired rechargeable battery or a wireless rechargeable battery. The wired rechargeable battery is a battery charged through a wired line, and the wireless rechargeable battery is a battery charged through a wireless coil. The rechargeable battery may also support the fast charging technology.

In some embodiments, the electronic device 1400 also includes one or more sensors 1410. The one or more sensors 1410 include, but are not limited to, an acceleration sensor 1411, a gyro sensor 1412, a pressure sensor 1413, an optical sensor 1414 and a proximity sensor 1415.

In some embodiments, the acceleration sensor 1411 detects magnitudes of accelerations on three coordinate axes of a coordinate system established by the electronic device 1400. For example, the acceleration sensor 1411 is configured to detect components of a gravitational acceleration on the three coordinate axes. In some embodiments, the processor 1401 controls the display screen 1405 to display a user interface in a landscape view or a portrait view according to a gravity acceleration signal collected by the acceleration sensor 1411. In some embodiments, the acceleration sensor 1411 is also configured to collect motion data of a game or a user.

In some embodiments, the gyro sensor 1412 detects a body direction and a rotation angle of the electronic device 1400, and can cooperate with the acceleration sensor 1411 to collect a 3D motion of the user on the electronic device 1400. Based on the data collected by the gyro sensor 1412, the processor 1401 serves the following functions: motion sensing (such as changing the UI according to a user's tilt operation), image stabilization during shooting, game control and inertial navigation.

In some embodiments, the pressure sensor 1413 is disposed on a side frame of the electronic device 1400 and/or a lower layer of the display screen 1405. When the pressure sensor 1413 is disposed on the side frame of the electronic device 1400, a user's holding signal to the electronic device 1400 can be detected. The processor 1401 can perform left-right hand recognition or quick operation according to the holding signal collected by the pressure sensor 1413. When the pressure sensor 1413 is disposed on the lower layer of the touch display screen 1405, the processor 1401 controls an operable control on the UI according to a user's pressure operation on the touch display screen 1405. The operable control includes at least one of a button control, a scroll bar control, an icon control and a menu control.

The optical sensor 1414 is configured to collect ambient light intensity. In one embodiment, the processor 1401 controls the display brightness of the display screen 1405 according to the ambient light intensity collected by the optical sensor 1414. Specifically, when the ambient light intensity is high, the display brightness of the touch display screen 1405 is increased; and when the ambient light intensity is low, the display brightness of the touch display screen 1405 is decreased. In other embodiments, the processor 1401 also dynamically adjusts shooting parameters of the camera component 1406 according to the ambient light intensity collected by the optical sensor 1414.

The proximity sensor 1415, also referred to as a distance sensor, is usually disposed on the front panel of the electronic device 1400. The proximity sensor 1415 is configured to capture a distance between the user and a front surface of the electronic device 1400. In some embodiments, when the proximity sensor 1415 detects that the distance between the user and the front surface of the electronic device 1400 becomes gradually smaller, the processor 1401 controls the display screen 1505 to switch from a screen-on state to a screen-off state. When it is detected that the distance between the user and the front surface of the electronic device 1400 gradually increases, the processor 1401 controls the display screen 1405 to switch from the screen-off state to the screen-on state.

It will be understood by those skilled in the art that the structure shown in FIG. 14 does not constitute a limitation to the electronic device 1400, and may include more or less components than those illustrated, or combine some components or adopt different component arrangements.

In some embodiments, a non-volatile computer-readable storage medium including instructions, such as a memory including instructions, is provided, wherein the instructions, when executed by a processor of an electronic device, cause the electronic device to perform the method for displaying the prompt text in the above method embodiment. In some embodiments, the computer-readable storage medium is a read-only memory (ROM), a random access memory (RAM), a compact-disc read-only memory (CD-ROM), a magnetic tape, a floppy disk, an optical data storage device, and the like.

In some embodiments, a computer program product is further provided. The computer program product includes a computer program, which, when executed by a processor, causes the processor to perform the method for displaying the prompt text as described above.

In some embodiments, the computer program involved in the embodiments of the present disclosure is deployed and executed on one computer device, or executed on a plurality of computer devices located at one site, or executed on a plurality of computer devices distributed at plurality of locations and interconnected by a communication network. The plurality of computer devices distributed at a plurality of locations and interconnected by the communication network may form a blockchain system.

All the embodiments of the present disclosure can be implemented independently or in combination with other embodiments, all of which are all regarded as the protection scope claimed by the present disclosure.

1. A method for displaying a prompt text, which is performed by an electronic device and comprises:
collecting content information generated in a speaking process of a target object;
obtaining identification information by identifying the content information, wherein the identification information indicates speaking progress of the target object; and
displaying the prompt text based on the identification information, so that a prompt text fragment as highlighted in the prompt text matches the speaking progress of the target object.

2. The method according to claim 1, wherein collecting content information generated in the speaking process of the target object comprises:
obtaining a video fragment by shooting the target object in the speaking process of the target object; and
obtaining the identification information by identifying the content information comprises:
obtaining a text fragment corresponding to the video fragment by identifying the video fragment by lip language.

3. The method according to claim 1, wherein collecting the content information generated in the speaking process of the target object comprises:
collecting a voice fragment generated in the speaking process of the target object; and
obtaining the identification information by identifying the content information comprises:
obtaining a text fragment corresponding to the voice fragment by performing voice identification on the voice fragment.

4. The method according to claim 1, wherein the identification information is a text fragment spoken by the target object, and displaying the prompt text based on the identification information, so that the prompt text fragment as highlighted in the prompt text matches the speaking progress of the target, comprises:
determining, based on the text fragment, the prompt text fragment matching the text fragment from the prompt text; and
highlighting the prompt text fragment in a case of displaying the prompt text.

5. The method according to claim 4, wherein highlighting the prompt text fragment in the case of displaying the prompt text comprises:
displaying the prompt text fragment in a target display style, wherein the target display style is different from a display style of other text fragments in the prompt text; or
scrolling each text fragment in the prompt text, so that the prompt text fragment is displayed in a focal position in a current interface.

6. The method according to claim 1, further comprising:
acquiring the prompt text as inputted based on a prompt interface;
wherein displaying the prompt text based on the identification information, so that the prompt text fragment as highlighted in the prompt text matches the speaking progress of the target object, comprises:
displaying the prompt text in the prompt interface based on the identification information, so that the prompt text fragment as highlighted in the prompt text matches the speaking progress of the target object.

7. The method according to claim 6, further comprising:
displaying the prompt interface in response to a trigger operation on a prompt entry in a current interface.

8. The method according to claim 7, wherein the current interface is a video shooting interface, and the method further comprises:
shooting a video in a process of displaying the prompt text in the prompt interface.

9. The method according to claim 7, wherein the current interface is a video shooting interface, and displaying the prompt interface in response to the trigger operation on the prompt entry in the current interface comprises:
displaying the prompt interface in an upper layer of the video shooting interface in response to the trigger operation on the prompt entry, wherein the prompt interface is in a transparent or translucent state.

10. The method according to claim 6, wherein the prompt interface includes a mode option configured to turn on a uniform speed mode or a non-uniform speed mode, the uniform speed mode being configured to scroll each text fragment in the prompt text at a uniform speed, and the non-uniform speed mode being configured to display the prompt text based on the speaking progress of the target object; and the method further comprises:
performing collecting the content information generated in the speaking process of the target object in a case that the non-uniform speed mode is turned on based on the mode option.

11. The method according to claim 10, further comprising:
displaying each text fragment in the prompt text in a scrolling manner based on a preset speed in a case that the uniform speed mode is turned on based on the mode option.

12. An electronic device, comprising a processor and a memory storing at least one computer program therein, wherein the processor, when loading and executing the at least one computer program, is caused to perform:
collecting content information generated in a speaking process of a target object;
obtaining identification information by identifying the content information, wherein the identification information indicates speaking progress of the target object; and
displaying a prompt text based on the identification information, so that a prompt text fragment as highlighted in the prompt text matches the speaking progress of the target object.

13. The electronic device according to claim 12, wherein the processor, when loading and executing the at least one computer program, is caused to perform:
obtaining a video fragment by shooting the target object in the speaking process of the target object; and
obtaining a text fragment corresponding to the video fragment by identifying the video fragment by lip language.

14. The electronic device according to claim 12, wherein the processor, when loading and executing the at least one computer program, is caused to perform:
collecting a voice fragment generated in the speaking process of the target object; and
obtaining a text fragment corresponding to the voice fragment by performing voice identification on the voice fragment.

15. The electronic device according to claim 12, wherein the identification information is a text fragment spoken by the target object, and the processor, when loading and executing the at least one computer program, is caused to perform:
determining, based on the text fragment, the prompt text fragment matching the text fragment from the prompt text; and
highlighting the prompt text fragment in a case of displaying the prompt text.

16. The electronic device according to claim 15, wherein the processor, when loading and executing the at least one computer program, is caused to perform:
displaying the prompt text fragment in a target display style, wherein the target display style is different from a display style of other text fragment in the prompt text; or
scrolling each text fragment in the prompt text, so that the prompt text fragment is displayed in a focal position in a current interface.

17. The electronic device according to claim 12, wherein the processor, when loading and executing the at least one computer program, is caused to perform:
acquiring the prompt text as inputted based on a prompt interface;
wherein displaying the prompt text based on the identification information, so that the prompt text fragment as highlighted in the prompt text matches the speaking progress of the target object, comprises:
displaying the prompt text in the prompt interface based on the identification information, so that the prompt text fragment as highlighted in the prompt text matches the speaking progress of the target object.

18. The electronic device according to claim 17, wherein the processor, when loading and executing the at least one computer program, is caused to perform:
displaying the prompt interface in response to a trigger operation on a prompt entry in a current interface.

19. The electronic device according to claim 18, wherein the current interface is a video shooting interface, and the processor, when loading and executing the at least one computer program, is caused to perform:
shooting a video in a process of displaying the prompt text in the prompt interface.

20. A non-volatile computer-readable storage medium storing instructions therein, wherein the instructions, when executed by a processor of an electronic device, cause the electronic device to perform:
collecting content information generated in a speaking process of a target object;
obtaining identification information by identifying the content information, wherein the identification information indicates speaking progress of the target object; and
displaying the prompt text based on the identification information, so that a prompt text fragment as highlighted in the prompt text matches the speaking progress of the target object.
